(19) United States
(12) Patent Application Publication
(10) Pub. No.: US 2008/0177590 A1
(43) Pub. Date: Jul. 24, 2008

(54) Vehicle-Lead Generating Systems

(75) Inventors: BARRY S. BRODSKY, SCOTTSDALE, AZ (US); CORNELIUS KEMP, HAGERSTOWN, IN (US)

Correspondence Address: LAW OFFICE OF ANDREW P. LAHSER, PLC, 13239 N. LA MONTANA, SUITE 215, FOUNTAIN HILLS, AZ, 85268, US

(73) Assignee: GetAutoAppraise, LLC, Scottsdale, AZ (US)

(21) Appl. No.: 11/860,534

(22) Filed: Sep. 24, 2007

Related U.S. Application Data
(60) Provisional application No. 60/846,401, filed on Sep. 22, 2006.

(51) Int. Cl. G06F 9/44; G06F 17/30

(52) U.S. Cl. 705/7; 707/10

(57) ABSTRACT

The disclosure provides for a system that stores electronically information regarding used-vehicles, including used-vehicle values; presents, to a consumer over an network, a list of used-vehicle information (by year, make, model, body, engine, optional equipment or other classification depending on vehicle type) within a structured document, (for example, a web page); accepting inputting, from such consumer, a selection from the list; modifying a portion of the structured document to include a sub list of used-vehicle information, wherein the sub-list derives from the selection; repeating the step of accepting inputting and the step of modifying to determine the used-vehicle value, whereby the used-vehicle value relates to the selection of the consumer; and presenting the used-vehicle value to the consumer.

### CROSS REFERENCE TO RELATED APPLICATIONS

The present application is related to prior provisional application Ser. No. 60/846,401 filed Sep. 22, 2006, the contents of which are incorporated herein by this reference and are not admitted to be prior art with respect to the present invention by the mention in this cross-reference section.

### BRIEF DESCRIPTION OF THE DRAWINGS

FIG. 1 shows a use-case diagram illustrating a dealership, attracting potential consumers using a system that may provide the listed functions and information according to an embodiment of the present invention.

FIG. 2A, FIG. 2B and FIG. 2C show an activity diagram illustrating the flow of activities between a potential consumer and a dealership website as the consumer interacts with the dealership website according to an embodiment of the present invention.

FIG. 3A, FIG. 3B, FIG. 3C, FIG. 3D, and FIG. 3E show a series of computer screenshots illustrating the progressive, asynchronous updating of lists on a webpage to assist the consumer in selecting the vehicle for appraisal according to embodiment of the present invention.

FIG. 4 shows a sequence diagram illustrating the sequence of program calls between the consumer's Web browser, the systems Web server, the vehicle valuation database, and the dealership's multimedia templates, which allow the system to interactively update the consumer's Web browser and prompt the consumer to continue the process according to another embodiment of the present invention.

FIG. 5 shows a computer screenshot illustrating the upper portion of the contact information Web form, including an example of a dealership multimedia template according to embodiment of the present invention.

FIG. 6A, FIG. 6B, FIG. 6C, FIG. 6D, FIG. 6E show series of computer screenshots illustrating the progressive, asynchronous updating of a webpage to assist the consumer to enter the consumer's contact information and desired new vehicle according to an embodiment of the present invention.

FIG. 7A and FIG. 7B show the upper portion and lower portion (respectively) of a computer screenshot illustrating the vehicle appraisal report according to an embodiment of the present invention.

FIG. 8 shows a computer screenshot illustrating a portion of the configuration screen to allow a dealership to integrate the system with the dealership website according to embodiment of the present invention.

FIG. 9 shows a computer screenshot illustrating a portion of the configuration screen to allow a dealership to add multimedia aspects into the system's multimedia templates according to an embodiment of the present invention.

FIG. 10 shows a computer screenshot illustrating a portion of a lead report according to an embodiment of the present invention.

### DETAILED DESCRIPTION OF THE DRAWINGS

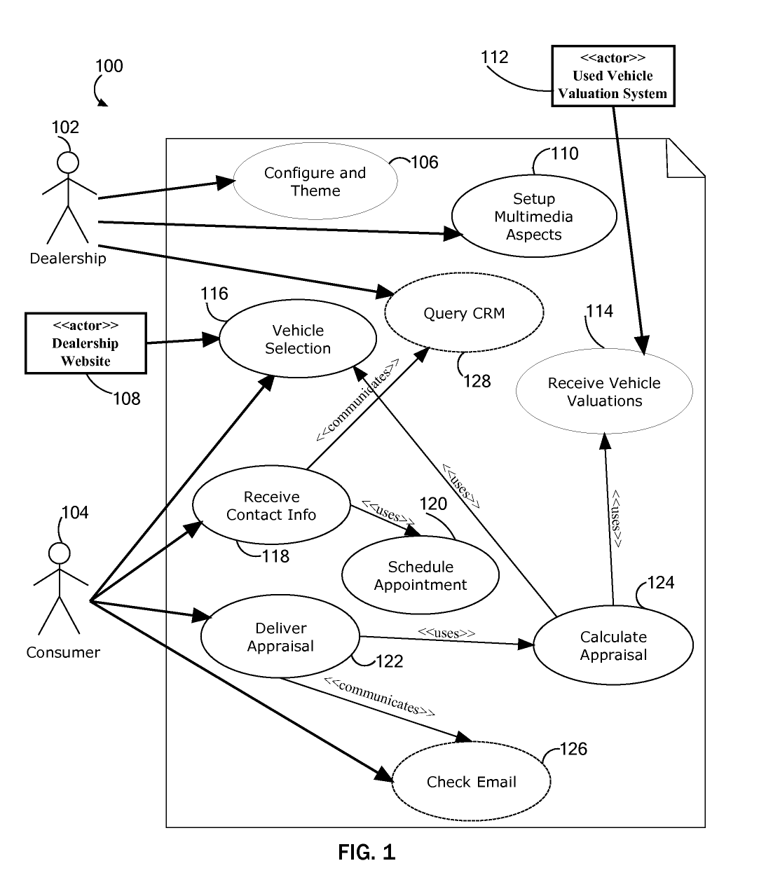

FIG. 1 shows a use-case diagram illustrating dealership 102 attracting potential consumers 104 using system 100 that may provide the listed functions and information according to an embodiment of the present invention. Dealership 102 may sell vehicles and may have a website for advertising its vehicles. Dealership 102 may offer a used a vehicle appraisal on its website to help induce consumer 104 to provide the contact information of consumer 104 to dealership 102, thereby allowing (giving permission for) dealership 102 to contact consumer 104 as a sales lead. System 100 may provide the features and information to capture the contact information of consumer 104 and deliver the promised vehicle appraisal while providing a responsive, interactive experience for consumer 104, as shown.

Dealership 102 may configure system 100 using configure function 106. Configure function 106 may allow dealership 102 to set up any system configuration parameters necessary to provide a responsive, interactive experience and properly qualify any potential consumers, such as consumer 104, as shown. For example, configure function 106 may allow dealership 102 to indicate the vehicle makes that are offered for sale at dealership 102. For example, configure function 106 may allow dealership 102 to indicate the desired colors for the user interface so that system 100 may match the color and theme of the dealership-website 108. For example, configure function 106 may allow dealership 102 to indicate the primary language for its potential consumers, e.g. English, Spanish, etc. For example, configure function 106 may allow dealership 102 to indicate how the appraisal may be delivered, such as, by e-mail, by the Web, by fax, etc., or some combination. For example, configure function 106 may allow dealership 102 to indicate the uniform resource locator (URL), where system 100 may be accessed by potential consumers at dealership-website 108 over the Internet.

Dealership 102 may further set up system 100 using function set-up-multimedia-aspects 110, as shown. Dealership 102 may enter multimedia into system 100 for display by system 100. Multimedia may include audio, video, animation, or combinations thereof. The multimedia entered or uploaded over the Internet by dealership 102 may be combined with multimedia provided by system 100. System 100 may combine the aspects of the multimedia entered by the dealership with aspects from its own templates.

Dealership 102 may further require information about used vehicles, such as, used vehicle valuations, may be uploaded (or otherwise entered) into system 100, as shown. Used vehicle valuation system 112 may upload used vehicle valuations for use by system 100, as shown. Used vehicle valuations may include information about the particular years, makes, models that were manufactured and available for consumer purchase. Additionally, used vehicle valuations may include information about options that were available for each year, make, model, body, engine, etc. Additionally, used vehicle valuations may include information about classifying used vehicle condition, for example, into three classes: “Clean,” “Average”, and “Rough.” A “clean vehicle” may show some normal wear but has no major mechanical and/or cosmetic problems; the exterior paint still has a glossy finish and may have slight scratches or dings; some reconditioning may be needed; the interior will have minimal fading and wear; the tires have substantial tread remaining; the vehicle has a clean title; the vehicle has the ability to pass an emissions inspection. An “average vehicle” may have a few mechanical and/or cosmetic problems and may require a considerable amount of reconditioning; the exterior paint has some dullness; the vehicle may have a considerable amount of scratches or dings; the interior material is slightly worn and faded; the tires have some useable tread remaining; the vehicle has a clean title; the vehicle has the ability to pass an emissions inspection. A “rough vehicle” has several mechanical and/or cosmetic problems; the exterior and interior need significant repairs; the tires may need to be replaced; the vehicle may need minor repairs to pass an emissions inspection, but it has a clean title. In addition to classifying vehicles by condition, the used vehicle valuations may further classify vehicles by geographical location such as, for example, by state, city, zip code, or any other convenient geographical description. Finally, used vehicle valuations may include an amount or range of values for used vehicles. To determine a specific amount (or specific range of values) for a specific used vehicle, system 100 could query these vehicle valuations data using the vehicle year, make, model, body, engine, optional equipment, condition, mileage, and geographic location. Under appropriate circumstances, the information required to determine a used-vehicle value may depend on the format, structure, and/or provider (i.e. the third-party that collects the used-vehicle values) of the used-vehicle valuation data, however, the necessary data elements may be captured in substantially the same way regardless of the format.

Upon reading the teachings of this specification, those skilled in the art will now realize that, considering such issues as vehicle market value, web traffic, cost per lead, marketing opportunities, other types of vehicles (and their corresponding dealerships), vehicle type, advances in vehicle technology, advances in appraisal of used vehicles, economic considerations, advances in programming technology, advances in Internet protocols or networked communications, etc., other types of vehicles, such as, for example, automobiles, motorcycles, recreational vehicles, mopeds, scooters, a car, light-duty truck, sport-utility-vehicle, motorcycle, alternative-fuel vehicle, off-road vehicle, recreational vehicle, etc., may suffice.

Dealership 102 may need to configure dealership website 108 so that dealership website displays system 100 upon dealership website 108. Dealership website 108 may include a hypertext link to system 100. Dealership website 108 may include an HTML iframe (or other HTML frame) to allow system 100 to appear within dealership website 108. After configuration, potential consumers may interact with system 100, as shown.

After configuration and installation, consumer 104 may interact with system 100 and dealership website 108 by communicating with dealership website 108 using a personal computer to transmit requests over the Internet to dealership website 108, as shown. Consumer 104 begins at dealership website 108 where consumer 104 may view the system 100 by either clicking on a link, viewing the HTML frame, or otherwise accessing system 100 after accessing dealership website 108.

Consumer 104 will first indicate their current vehicle, or other vehicle for which they wish an used-vehicle appraisal, using vehicle-selection function 116, as shown. Consumer 104 will indicate the year, make, model, equipment options, condition, mileage, geographic location, and other information useful for determining the value of the vehicle. Consumer 104 may be presented with multimedia prompts as consumer 104 completes entry of any of the required fields. Consumer 104 may be presented with additional fields and consumer 104 completes the existing fields. This may be because the additional fields depend upon the answers of the previous fields. The may also be because showing less fields to the consumer 104 encourages the consumer to complete the smaller number of fields.

Consumer 104 will next indicate their contact information using receive-contact-info function 118 by providing their name, phone number, and e-mail address. Consumer 104 may be presented with multimedia prompts or multimedia offers as an additional inducement to provide the contact information and proceed to the final page which includes the appraisal information. Consumer 104 may indicate their desired new vehicle and the timeframe in which consumer 104 may wish to purchase. Consumer 104 may indicate using schedule-appointment function 120 that they wish to schedule a day and time for an appointment to review the appraisal with dealership 102.

Consumer 104 will finally view the used vehicle appraisal report by using the deliver-appraisal function 122, as shown. Deliver-appraisal function 122 uses several other functions to ascertain the likely value or range of values for the used vehicle, as shown. Deliver-appraisal function 122 uses the calculate-appraisal function 124, as shown. Calculate-appraisal function 124 uses the input of consumer 104 from vehicle-selection function 116 in order to properly query the used vehicle valuations information obtained by receive-vehicle-valuations function 114, as shown. That is, calculate-appraisal function 124 uses the year, make, model, optional equipment, geographic location, mileage, vehicle condition, and other information useful for determining the value of a vehicle to determine a value from the used vehicle valuations. After determining a value or range of values, deliver-appraisal function 122 may display the vehicle value to consumer 104 over the Internet. Alternately, deliver-appraisal function 122 may transmit the vehicle appraisal information by email or other method. Deliver appraisal function may also transmit the contact information of consumer 104 to dealership 102, such as, for example, by email, by website report, by integration with the dealerships CRM system, or etc.

Thereafter, dealership 102 may query system 100 to view the contact information of consumer 104. Dealership 102 may also query their separate CRM system using query-CRM function 128, as shown, if system 100 has been integrated with this separate CRM system.

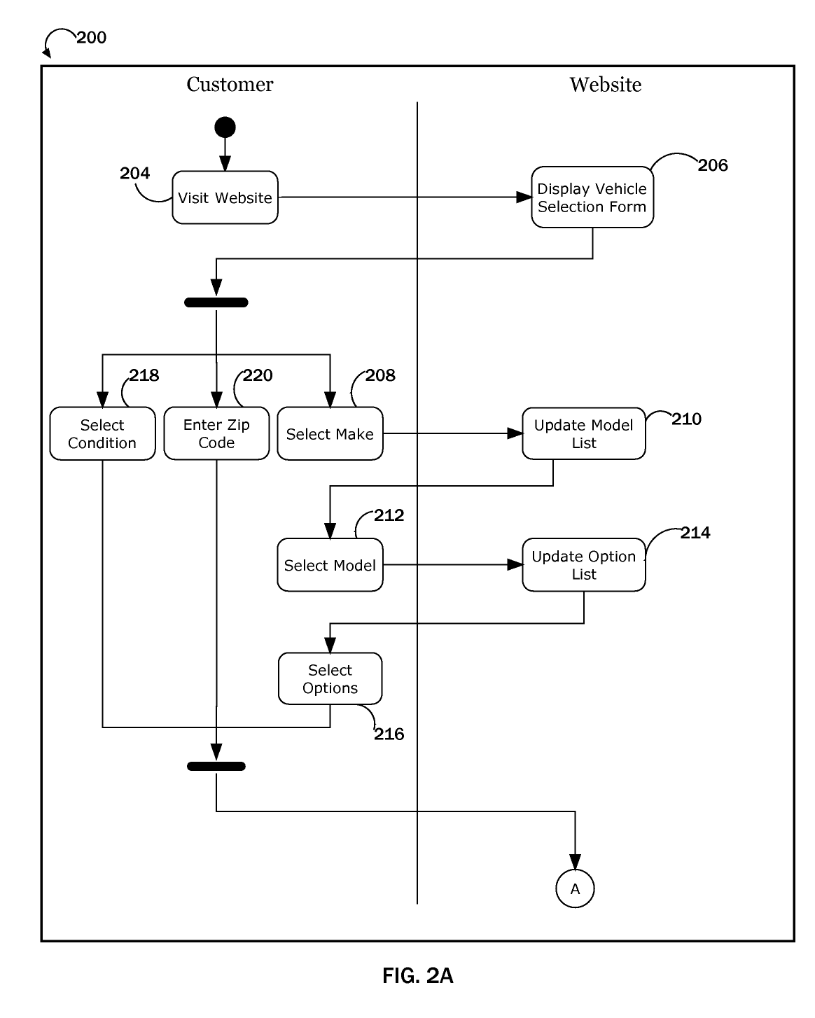

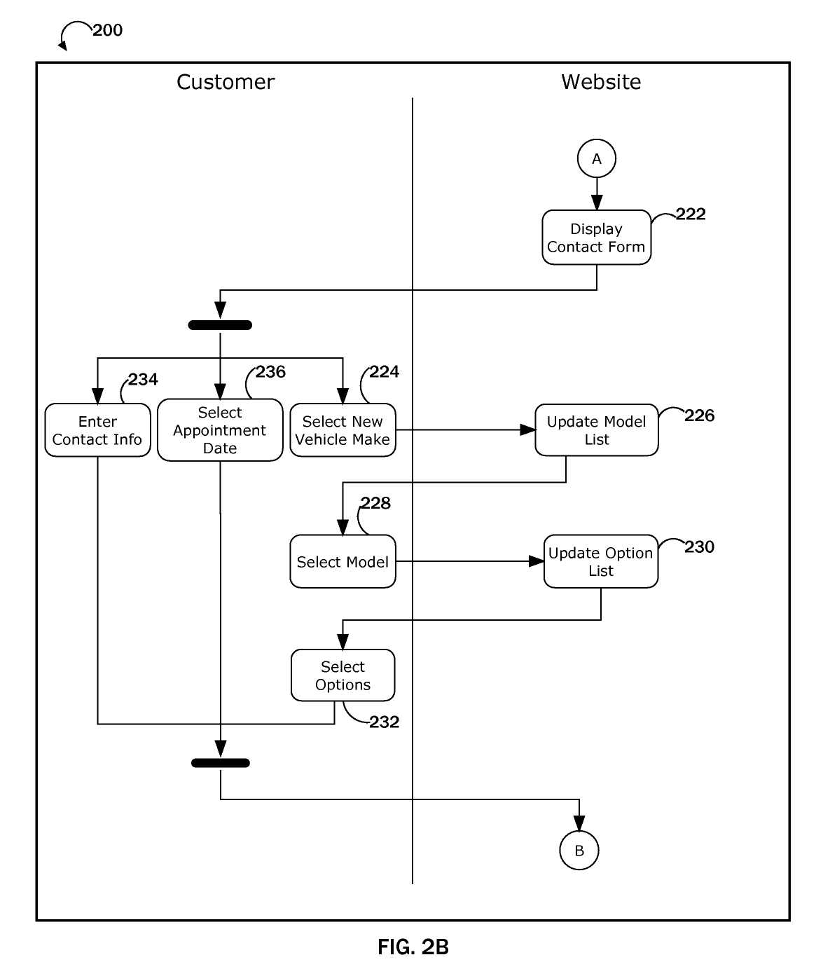

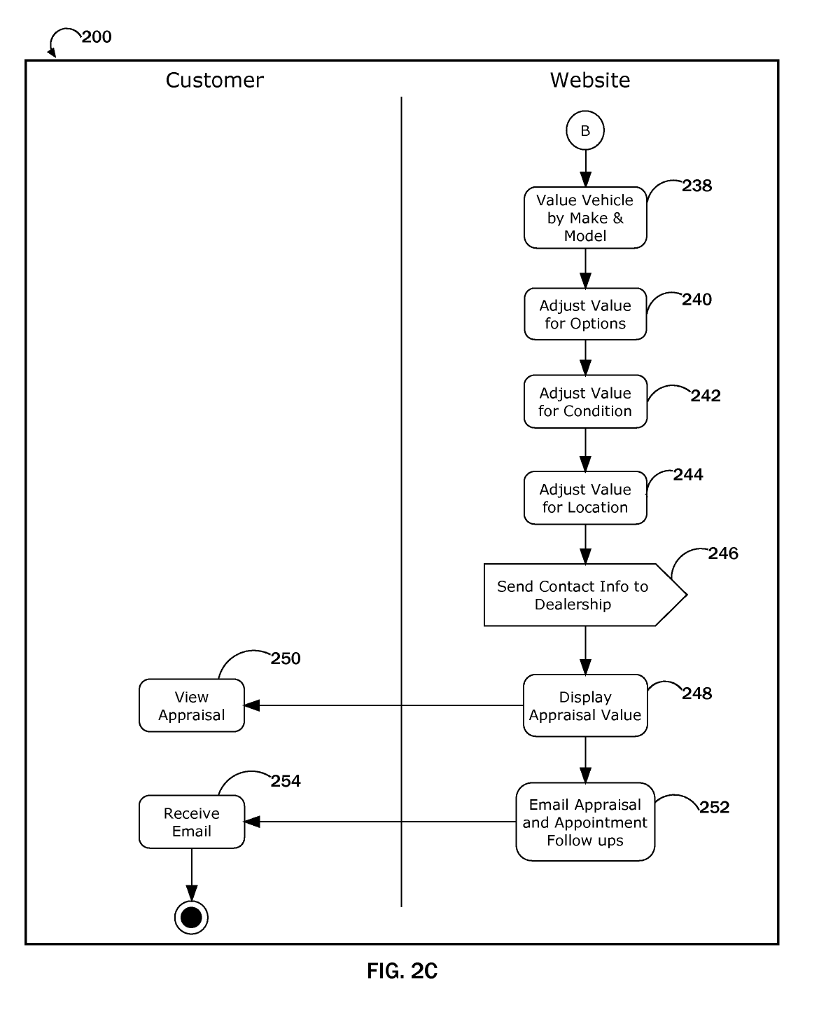

Turning now to FIGS. 2A to 2C, and considering them together, they show an activity diagram illustrating the flow of activities between a potential consumer and a dealership website as the consumer interacts with the dealership website. The process begins when the consumer uses a web browser to visit the website of the dealership during the activity Visit Website 204, as shown. The website responds by presenting a web page that contains a form for entering information about the vehicle that the consumer wishes to appraise during activity Display Vehicle Selection Form 206, as shown.

When the consumer selects a vehicle model (and year) during activity Select Model 208, the website undertakes activity Update Model List 210 and asynchronously sends a list of available models so that the webpage can update the webpage's list of vehicle makes so that the consumer may then specify the vehicle make. By using this method, the user experiences an interactive and responsive interface similar to an application running on the consumer's own computer. Applicant notes that such a system helps prevent “drop-off”, that is, consumers that use such a interactive and responsive system appear to be more likely to complete the process by providing contact information. The consumer then selects the vehicle model during activity Select Model 212. The website then updates the optional equipment during activity Update Option List 214; the website uses the previously identified year, make, and model to determine the available equipment. Similarly, there may be additional activities for vehicles types that require body style, engine type, or other categories or equipment. The webpage is then updated so that the user can select the equipment during activity Select Options 216, as shown. In some embodiments, the value of each equipment option may be displayed along with the equipment during selection.

Upon reading the teachings of this specification, those skilled in the art will now realize that, considering such issues as vehicle type, advances in vehicle technology, advances in appraisal of used vehicles, economic considerations, advances in programming technology, advances in Internet protocols or networked communications, etc., other selection or valuation criteria may suffice.

The vehicle models offered can also depend upon the model year. In such a case, the website would build a list of models available in the indicated year and update the webpage similarly. However, due to the limited number of vehicle makes, whenever network latency is sufficiently high, all years and models may be specified in the initial web page, thereby reducing the number of transactions and increasing the perceived interactivity and responsiveness for the consumer.

The consumer need not first enter the year, make, model and other details. Instead, the consumer may enter the geographic location of the vehicle, such as, during activity Enter Zip Code 220, as shown. The consumer may also enter the condition (or mileage, or other details related to condition) of the vehicle at any time during activity Select Condition 218, as the condition of the vehicle does not depend on any of the other information being provided by the consumer. After entering all of the information and detail needed to automatically produce an appraisal for the used vehicle, the website will display a second webpage for entering contact information during activity Display Contact Form 222, as shown.

The consumer may enter contact information, such as first name, last name, address, email address, fax number, or other information requested by the website during activity Enter Contact Info 234, as shown. The consumer may select a date and time for an appointment during activity Select Appointment Date 236. Applicant notes that when a consumer chooses to set a date and time for an appointment that the consumer is much more likely to purchase a new vehicle from the dealership. Consumer may also indicate which new vehicle that the consumer may consider purchasing. The selection of the desired new vehicle is made in a similar manner to selection of the used vehicle for appraisal. The consumer selects the desired new vehicle make (and year) during activity Select New Vehicle Make 224. The website asynchronously sends a list of models that are available for that make and year to the consumers web page during activity Update Model List 226. The consumer's web browser updates the web page to include the selection of available models so that the consumer can select a model during step Select Model 228. During activity Update Option List 230 the website then uses the selected model to determine the list of options (including color, and other options that may not be necessary for appraisal, but are strong indicators that the consumer has a specific vehicle in mind and is therefore a “hot” lead), that may be available. Then, the consumer can choose any remaining options, during activity Select Options 232. During selection of a new vehicle, the website may not require that optional equipment, body style, engine type, vehicle make or other details be selected, because this information need not be gathered to calculate the appraisal, but rather, to indicate the “hot” or “cold” quality of the lead. Also, the consumer could also indicate that they wish to buy a used vehicle, and would be again prompted for the type of used vehicle that they wish to purchase using a similar selection process. Since the contact information may be the only information or other value obtained for offering the appraisal service, the website may also take further steps to ensure that the email address or other contact information is valid, for example, that the email address has at least three parts corresponding to the email account, domain name, and the top level domain identifier (e.g. following the format: account@domain-name.com). For further example, that a phone number has 10 digits, or seven digits and a valid local calling prefix. For further example, that the email address has only a single @ sign. Alternately, the dealership may allow any information in order to streamline the process, avoid losing potential leads, and lower the “drop-off” rate.

After entering and validating contact information, the website will determine the appraisal value (or range of values) for the used vehicle for presentation to the user. First, the website may query the used vehicle valuation database with the vehicle year, vehicle make, vehicle model, and other details required by the format or structure of the used-vehicle appraisal valuations data, in order to determine an initial value, such as, during activity Value Vehicle by Make & Model 238, as shown. Next, the website may adjust that initial value for any optional equipment that may be installed, such as, during activity Adjust Value 240, as shown. Next, the website may adjust the appraisal value for the geographic location and condition, such as, during activity Adjust Value for Condition 242 and activity Adjust Value for Location 244, as shown. The website will now have a final value and also adjustments for the condition, location, and optional equipment (and possibly other adjustments that may vary by vehicle type). All of this information may be provided to the consumer.

The website will then transmit the consumer information to the dealership, such as, for example, by email, by RSS (really simple syndication) feed, by fax, by export, by file download or by direct integration with their CRM system, (or other electronic communications means) during activity Send Contact Information to Dealership 246, as shown.

Finally, during activity Display Appraisal Value 248, the website will display the third web page, which contains the vehicle information that the consumer previously entered adjacent to the appraisal information. The consumer can view the web page, during activity View Appraisal 250. The web page may itemize each factor to show how it pertains to (add or subtract from) the value of the vehicle. Alternately, the web page may show a single value or range of values. Alternately, during activity Email Appraisal and Appointment Follow Ups 252 and activity Receive Email 254 (as shown), the information may not be delivered through a web page, but rather through an email message or other electronic communication method.

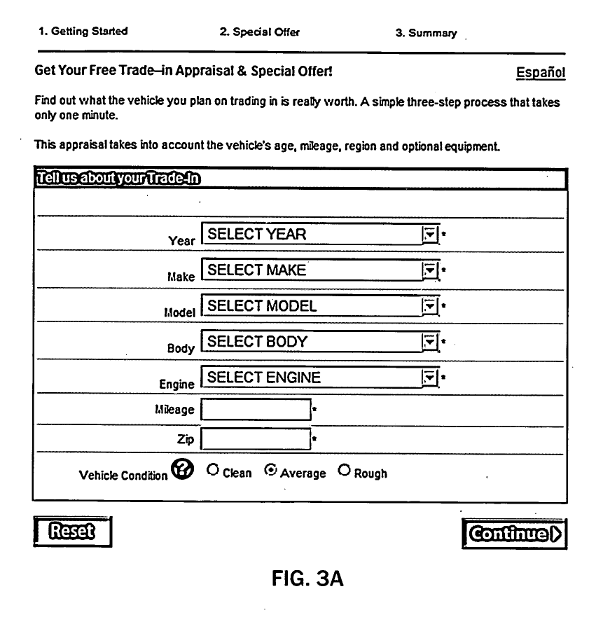

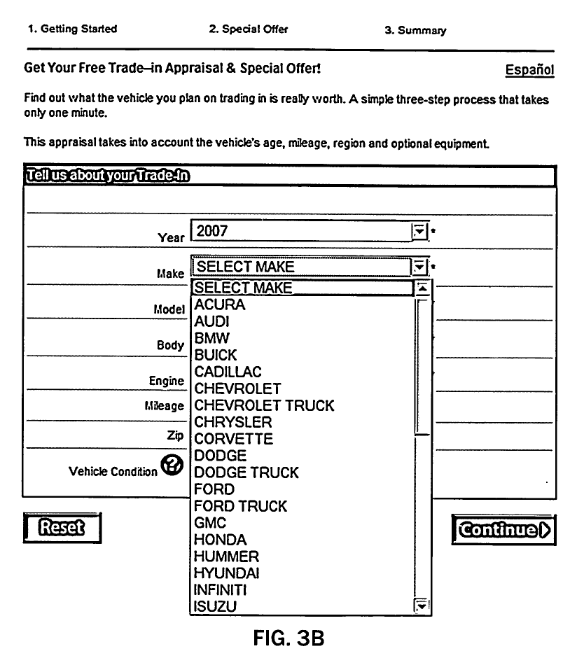

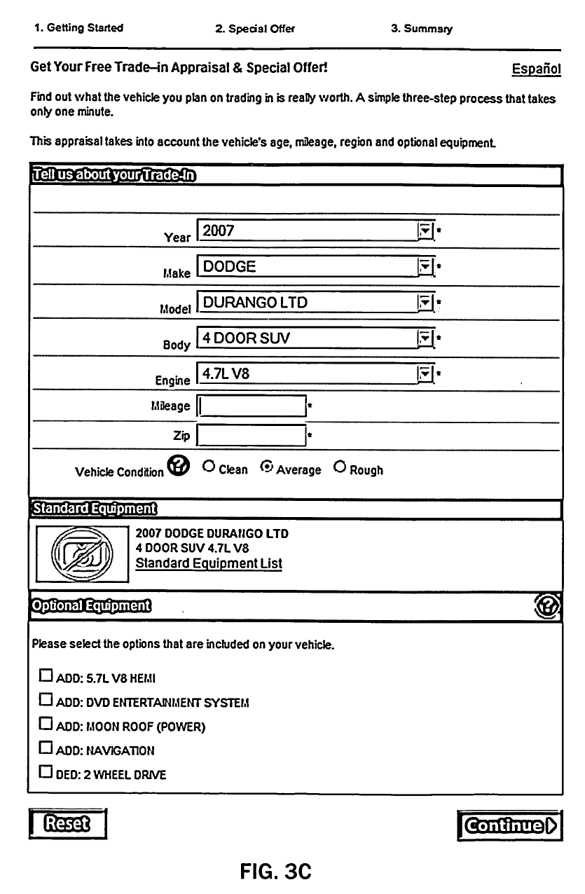

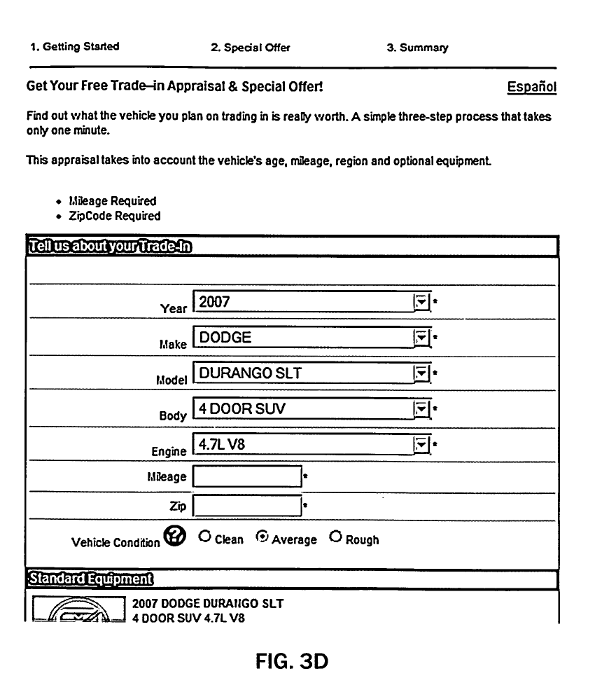

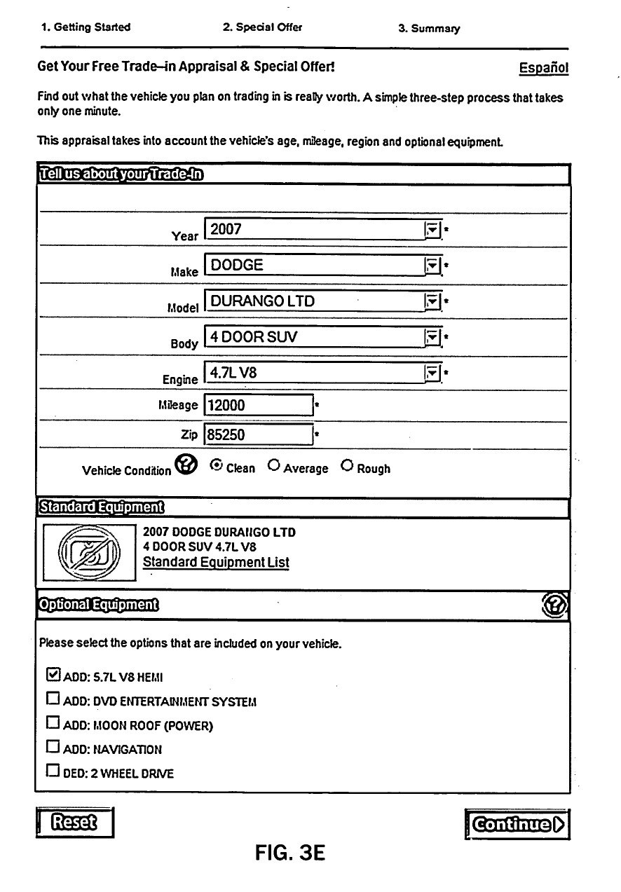

Turning now to FIGS. 3A to 3E, which show a series of computer screenshots illustrating the progressive, asynchronous updating of lists on a webpage to assist the consumer in selecting the vehicle for appraisal according to an embodiment of the present invention. FIG. 3A shows a blank web form that is awaiting consumer input regarding a vehicle. The web form shows fields for vehicle year, make, model, body, engine, mileage, zip code, and condition. By minimizing the number of fields initially presented, the consumer may consider that little information or time is needed to complete the process. Likewise, the navigation bar at the top indicates that only three steps are needed to complete the process: 1.) Getting Started, 2.) Special Offer and 3.) Summary. Also note that the vehicle condition has defaulted to “Average” so that the user need not even click the mouse one time in order to select the most common choice.

FIG. 3B shows the web form as the user has already made a selection for the year and is presently making a selection for the vehicle make. The various makes are visible in the drop-down list in the vehicle make field. FIG. 3C shows the web form after the user has selected the model. Note that the body and engine fields have been completed even though the user did not select them. In this case, a 2007 Dodge Durango LTD does not have any options for body style or engine type, that is, there are no other options for the body style or engine type. Since there are no options, the web form automatically selects the only available body and the only available engine, thereby not requiring the consumer to click on a list with just one selection. Further, the web form now shows five kinds of optional equipment. A link to a standard equipment list is provided so that the consumer may further confirm that the correct vehicle was selected or view the standard equipment.

FIG. 3D shows that the consumer tried to press the continue button without indicating the mileage or ZIP code for the vehicle. In this case, the website requires this information because, in this embodiment, this information may be needed to determine the used vehicle valuations pertinent to this vehicle and thereby the appraisal value. An error message is displayed (in prominent letters) that says “* Mileage Required, * Zip Code Required.” Note that the format of the used vehicle valuations information may require some or all of the make, model, condition, mileage, body, engine, condition, location, and other optional equipment in order to properly determine the value of the used vehicle.

FIG. 3E shows the consumer entering the mileage and ZIP code information along with checkmark next to the checkbox that indicates a 5.7 L V-8 hemi is installed in this particular used vehicle. Consumer may now successfully press the “Continue” button and proceed to the second web page where the website will collect consumer information.

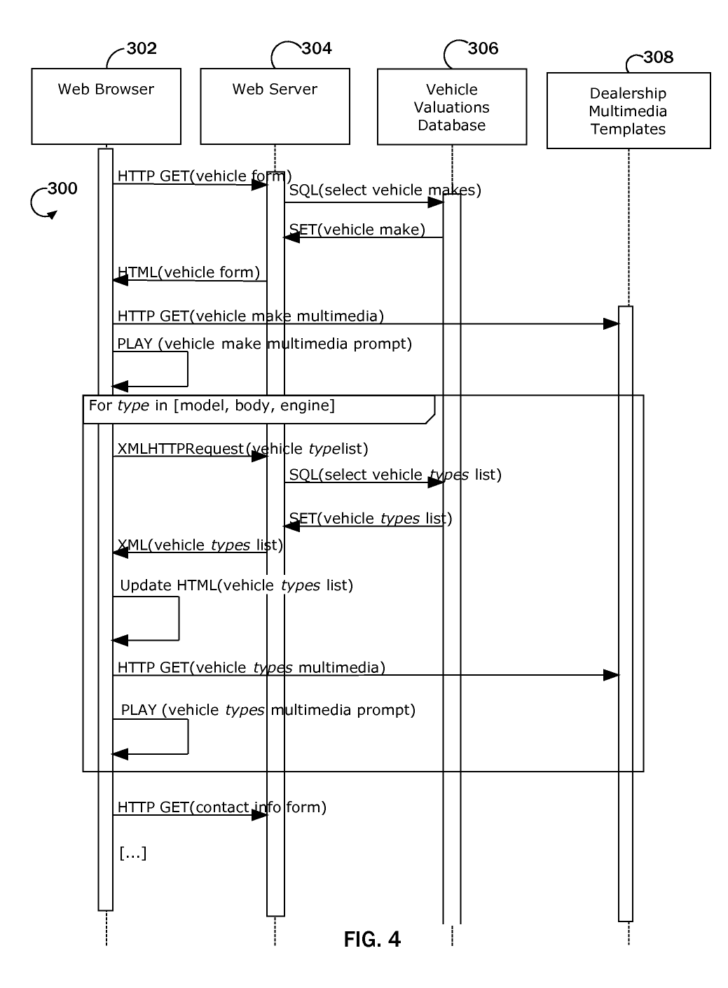

However, before turning to the second webpage, we will now turn to FIG. 4. FIG. 4 shows a sequence diagram illustrating the sequence of program calls between the consumer's Web browser, the systems Web server, the vehicle valuation database, and the dealership's multimedia templates, which allow the system to interactively update the consumer's Web browser and prompt the consumer to continue the process according to another embodiment of the present invention. In this embodiment, in addition to being presented with the web form to enter the information needed to calculate a used vehicle appraisal, the consumer is also presented with multimedia prompts that explain how to complete the appraisal process and encouraged the consumer to continue the appraisal process. System 300 shows the interaction between the following programs: Web browser 302, Web server 304, vehicle valuations database 306, and dealership multimedia templates 308.

Web browser 302 may be used by the consumer to access the dealership website and gain access to system 300. Web server 304 is connected to the Internet and operably responsive to HTTP protocol. Web server 304 serves web pages (such as HTML, XML, RSS and other structured documents) and otherwise responds to HTTP and XML requests. Vehicle valuations database 306 may be any database, including a flat file, ISAM, client/server, SQL, MySQL, Postgres, DB2, Oracle, object database, or other database or electronic storage method capable of storing data in a structured format suitable for querying by the categorization of the used-vehicle valuations data. Vehicle valuations database 306 may contain information related to the used vehicle valuations previously mentioned, that is, it may contain vehicle year, vehicle make, vehicle model, vehicle body, vehicle engine, optional equipment, mileage, geographic location, optional equipment, and a value (or range of values), whereby that value may be dependent upon some or all of the other factors listed here. Vehicle valuations database 306 may be provided by a third party. Displaying or otherwise representing that the data for such used-vehicle appraisals may induce consumers to complete the process of providing contact information.

Dealership multimedia templates 308 may contain multimedia, multimedia components or other multimedia aspects that may be combined to provide an interactive experience in web browser 302. Dealership multimedia templates 308 may be templates, that is, they may combine predetermined aspects along with aspects provided by the dealership such as, for example, an audio file recording of a dealership employee who is reading a predetermined script for helping a consumer complete the appraisal process. Another example, the multimedia may be a video file recording of a dealership employee who is presenting an offer for completing the contact information. For example, the multimedia may be a series of images, animation, or short video overlay (perhaps containing the likeness of a dealership owner) that points to the next field that requires input. System 300 may combine the aspects provided by the dealership with predetermined aspects provided by system 300. Alternately, the aspects may be combined outside of system 300 and made available to system 300. Dealership multimedia templates 308 may be contained in an operating system file system (flat file), a multimedia database, SQL database, an object database, or other electronic storage suitable for storing binary data objects, such as multimedia files and quickly providing them to web browsers. Alternately, the aspects may be combined by the database or other storage medium.

FIG. 4 shows a sequence of programming calls that are made by some of the programs involved in system 300 and responded to by other programs. FIG. 4 may be read from top to bottom, as is customary for sequence diagrams. The process starts when Web browser 302 performs an HTTP get requests for the vehicle selection form from Web server 304. Web server 304 queries the vehicle valuations database 306 to determine what vehicle makes and vehicle years are available in the vehicle valuations database 306, as shown. (Alternately, this information may not change and may be cached by the Web Server 304 or entered directly into the source code in order to improve responsiveness.) Vehicle valuations database 306 returns a set of vehicle makes that is included in the drop-down selection list on the vehicle selection form. Finally, Web server 304 sends the HTML that comprises the vehicle selection form to Web browser 302 that includes the vehicle selection form (similar to FIG. 3A), as shown.

Web browser 302 renders HTML to display to the consumer and thereby discovers that a multimedia file is needed for display. Web browser 302 requests the multimedia file from the Web server 304 which passes the call long to dealership multimedia templates 308, as shown. Web browser 302 then plays the vehicle make multimedia prompt on the same webpage as the vehicle selection form.

As consumer inputs the vehicle model, body style, and engine type, system 300 iterates through a series of programming calls that allow the webpage to update without re-presenting the entire webpage. This is commonly referred to as AJAX (i.e., Asynchronous JavaScript and XML). For each iteration, system 300 will make an XMLHTTPRequest for the needed list of vehicle models, vehicle body styles, vehicle engines, and vehicle optional equipment. That is, when the user selects a vehicle model, the iteration box will determine and display the list of vehicle makes. When the consumer selects a make, the system will determine and display a list of vehicle body styles. If there is more than one body style, the system will determine and display a list of vehicle engines. When the engine is selected, a list of equipment is determined and displayed. In addition to the list of equipment, an HTML snippet or a separate HTML frame may be needed to display the equipment list.

Turning now to step through each call in this iteration sequence, the first step occurs when Web browser 302 submits an XMLHTTPRequest that contains the vehicle year and vehicle model and expects a valid XML list of vehicle makes in response. Web server 304 creates an SQL command that selects the list of vehicle models related to the vehicle year and vehicle make from Vehicle valuations database 306. Web server 304 transmits an XML file to Web browser 302 that contains the list of valid and appropriate vehicle models. Web browser 302 updates the structure of the HTML document to include the contents of the XML document as items in the drop-down list for vehicle makes. Then, Web browser 302 makes the HTTP get request which is passed along by Web server 304 to dealership multimedia templates 308, thereby sending the multimedia prompt for vehicle makes to Web browser 302. Web browser 302 then plays the multimedia template prompt to the user on the same webpage.

The above described process will repeat for each portion of the webpage as the consumer completes entry of the information required to build the next logical portion of the web page selection criteria, for example, a list of vehicle body styles, a list of vehicle engine types, or a list of vehicle optional equipment. Likewise, the same process can be used for other portions of the system which require a vehicle selection. For example, when the consumer wants to indicate their desired new or used vehicle for which they may trade the current used vehicle.

After the entire vehicle selection form is entered, Web browser 302 transmits an HTTP get request to Web server 304 in order to request the contact information form. On the contact information form, the consumer will also be required to indicate the new or used vehicle that they desire, using a selection process similar to the one just described. However, the requirements there may be slightly different, as more, less or different information may be needed or desired by the dealership.

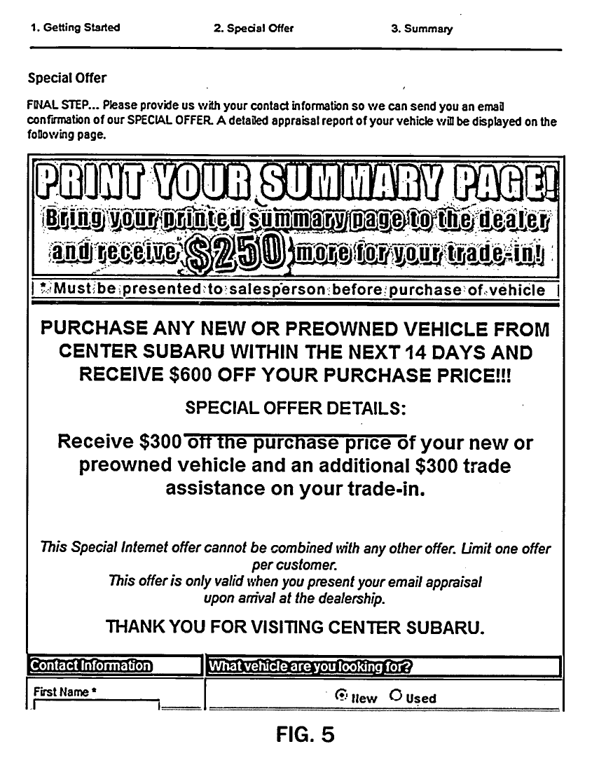

Turning now again to the series of computer screenshots, FIG. 5 shows a computer screenshot illustrating the upper portion of the contact information Web form, including an example of a dealership multimedia template, according to embodiment of the present invention. The navigation portion of FIG. 5 shows that the computer has now moved to the second page of the three page process, that is, the navigation bar shows the text “2.) Special Offer” as bold in the top portion of the computer screenshot. This upper portion of the computer screenshot shows a portion of a one type of dealership multimedia template which provide an additional offer or incentive to complete the contact information form. In this example, a banner graphic that says “Print your Summary Page” may be displayed along with the voice of a dealership employee or dealership owner who reads a script similar to the text underneath the banner graphic, that is, “Hi, I'm Dan Danson, owner of Center Subaru. If you print this web page by pressing CONTROL P right now, then you can bring this page with you to Center Subaru and purchase any new or preowned vehicle from Center Subaru within the next 14 days and receive $600 off.” This additional encouragement may induce the consumer to complete the webpage and provide the contact information. The consumer may feel some commitment to completing the process, because the consumer has already invested at least some time completing the vehicle selection form on the previous page.

The offer contained in the multimedia may be of a variety of types, such as, for example, manufacturer's incentives, dealership incentives, lender's incentives, lease company incentives, and combinations thereof.

Since multimedia, particularly audio, can be overwhelming in certain environments, system 300 may modify the multimedia depending on the consumer and the consumer's situation. For example, if the consumer is at work, or it is late at night in the consumer's timezone, the system may opt not to play audio, and instead subtitle the multimedia with the script. To determine the consumer's situation, the IP address (internet protocol address, that is, the network address) is used. Internet protocol addresses are generally registered to an entity. The entity may be a public company, a private business, an ISP (Internet Service Provider) or other entity. The type of entity can generally be determined using the name or other assumptions, for example, most home Internet access is provided by a small number of ISP in a geographical area. The system may assume that entities other than these identifiably ISP are companies or business where playing a loud audio program may be unsuitable. Likewise, the information about the local time zone may be attributed to the address of the registered entity. Once the time zone is known, the system may calculate the local time of day. So, for example, system 300 may choose not to play audio after 9 pm and before 6 am on weekdays, but always on weekends.

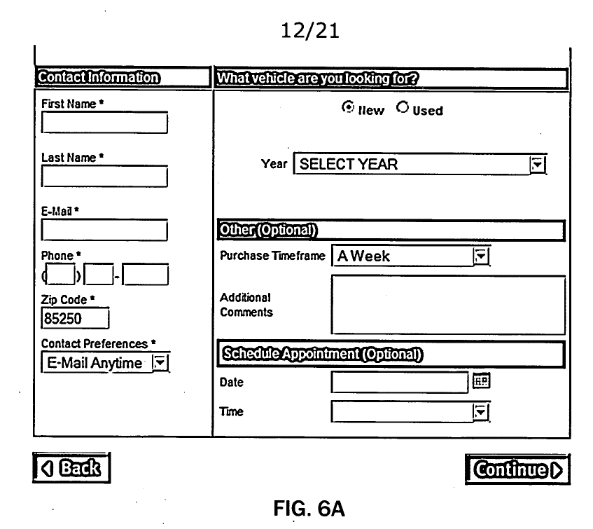

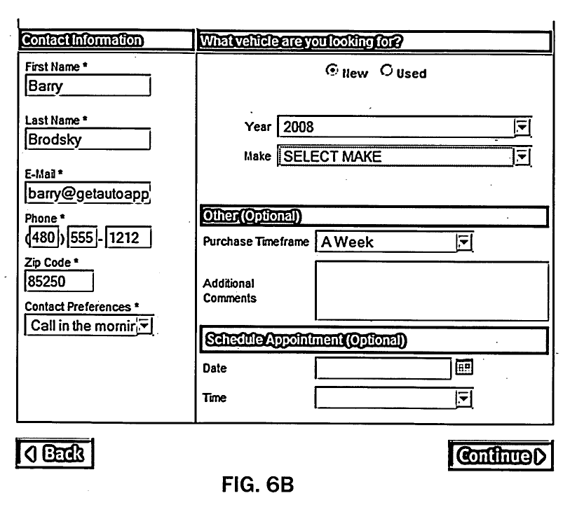

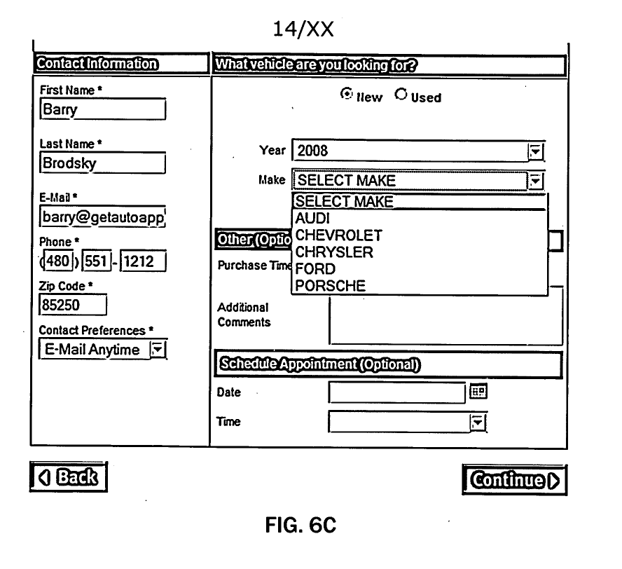

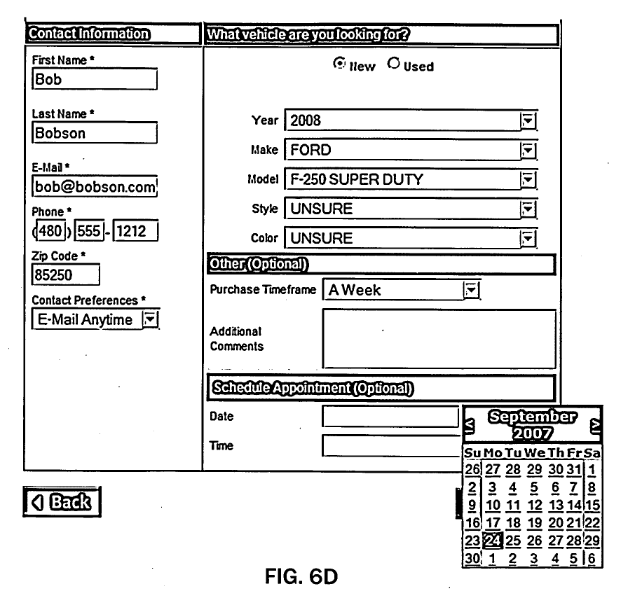

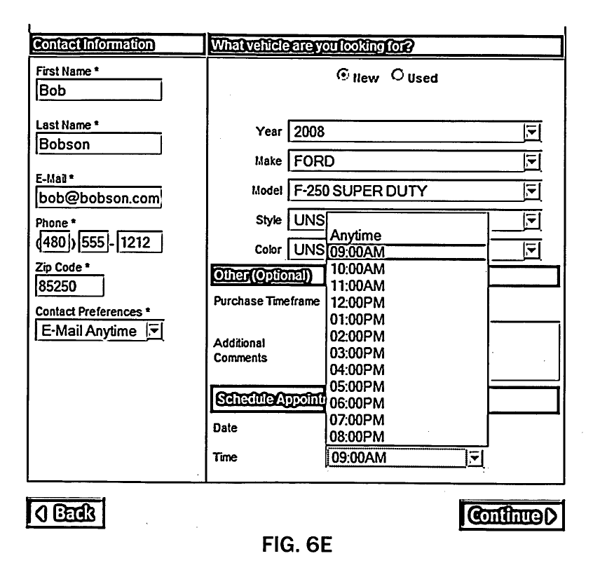

FIG. 6A to 6E show series of computer screenshots illustrating the bottom portion of the contact information web page as the consumer progresses through entering contact information and indication of a desired new vehicle according to an embodiment of the present invention. FIG. 6A shows a blank consumer contact information web form, before the consumer has had an opportunity to enter any information. The consumer contact information fields include first name, last name, e-mail, phone, ZIP code, and contact preference. When the form is blank, the new vehicle information preference form only has two fields, that is, the new/used radio group control and the year drop-down list. Again by only showing a few fields, the consumer is encouraged to enter the information provided, because it does not appear that much information will be required to complete the form. Other information is clearly indicated as optional. For example, the comments field is optional, the purchase timeframe is optional, and scheduling an appointment is optional.

FIG. 6B shows the consumer has now entered all of his contact information. The consumer has indicated that the consumer intends to purchase a new, 2008 model-year vehicle, within one week. The system has responded by adding a new field to indicate the vehicle make. FIG. 6C shows that the vehicle make field only indicates the makes that are sold by this particular dealership. FIG. 6D shows that the vehicle model, a vehicle style, and vehicle color may also be entered and added, one at a time, as the consumer completes the previous field. Note that the consumer may indicate when the consumer is unsure of a particular style or color. Finally, the FIG. 6D. shows that a pop-up calendar may be displayed in order to select a date for the appointment. This pop-up calendar also uses AJAX methods that were previously described. Finally, FIG. 6E shows the options for the various time periods that the consumer can visit the dealership during the dealership hours of operation. In some embodiments, the system may track previously scheduled appointments (or appointments scheduled in other systems, such as, for example the dealership CRM system) and ensure that the user may not select a date and time for which no salesperson may be available.

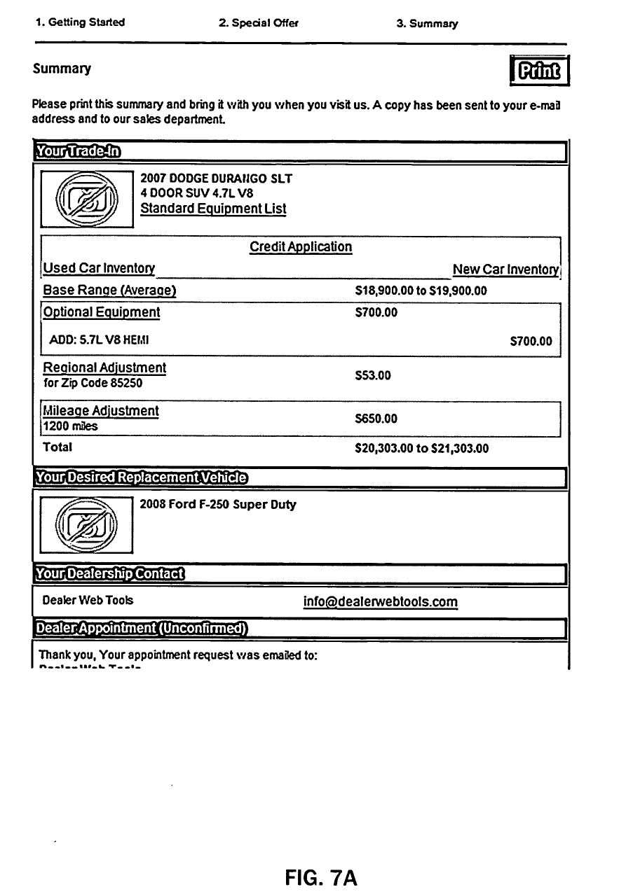

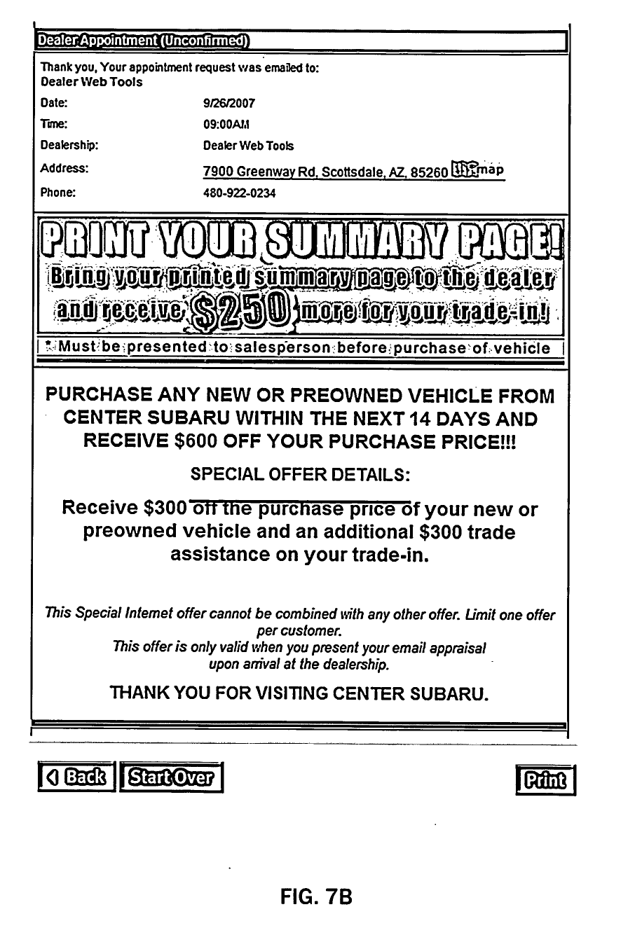

FIG. 7A and FIG. 7B show the upper portion and lower portion (respectively) of a computer screenshot illustrating the vehicle appraisal report according to an embodiment of the present invention. FIG. 7A shows the upper portion of the computer screenshot. This upper portion displays the information entered by the consumer, that is, the vehicle information, the optional equipment, the geographic location, and the mileage of the vehicle. Next to each of these elements of information, the specific monetary amount that each of these elements affects the overall appraisal is shown. Underneath, a total value range for this vehicle with this equipment in this region with this mileage as shown. Next, the information entered for the desired replacement vehicle is displayed. Following, dealership contact information is displayed, including, e-mail address, phone number, map, address, driving directions, hours of operation, etc., most of which is not shown in the computer screenshot. FIG. 7B shows the lower portion of the vehicle appraisal report. This portion of the report includes other details such appointment information, including, the date, time, name of the dealership, address, map, and phone number. Underneath that, the dealership multimedia template may be displayed, as it is here. The multimedia template may include elements which cannot be drawn, such as audio, video, animation, or other interactive elements. The multimedia template example seen here is similar to the one described in FIG. 5. A print button is prominently displayed as a logical final step for the vehicle appraisal report. The multimedia template may encourage printing so that a physical reminder of the dealership is present at the consumer's location immediately. The multimedia template may also prompt the user to print the screen in order to create a physical reminder of the vehicle appraisal report in the location of the consumer immediately. Physical printouts are likely to remain near the consumer and remind the consumer of the appraisal and the dealership.

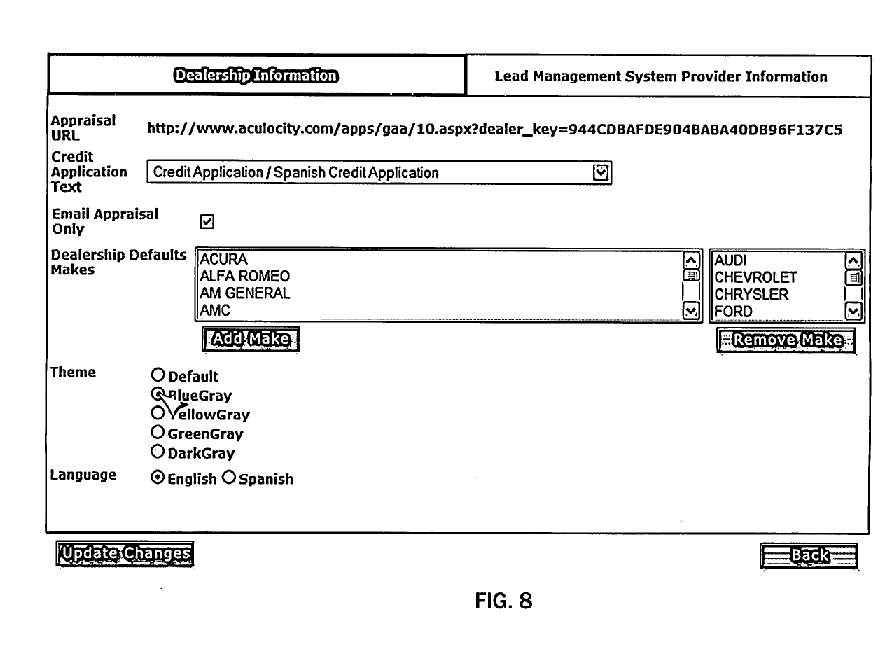

FIG. 8 shows a computer screenshot illustrating a portion of the configuration screen to allow a dealership to integrate the system with the dealership's website according to embodiment of the present invention. The screenshot shows that the dealership may select how the vehicle appraisal report should be delivered, such as, for example, the checkbox next to “Email Appraisal Only” (as shown), by the website, by fax, or by other electronic means (not shown). The screenshot shows an option for selecting language. The screenshot shows an option for selecting the theme, such as, for example, the colors used to display the system, such as, for example, when the system is operating within an iframe of a dealership website. Finally, the screenshot shows buttons for adding and removing vehicle makes and models that are sold by the dealership. This information is used to populate the new vehicle information on the contact information screen whenever the user selects a “New” vehicle.

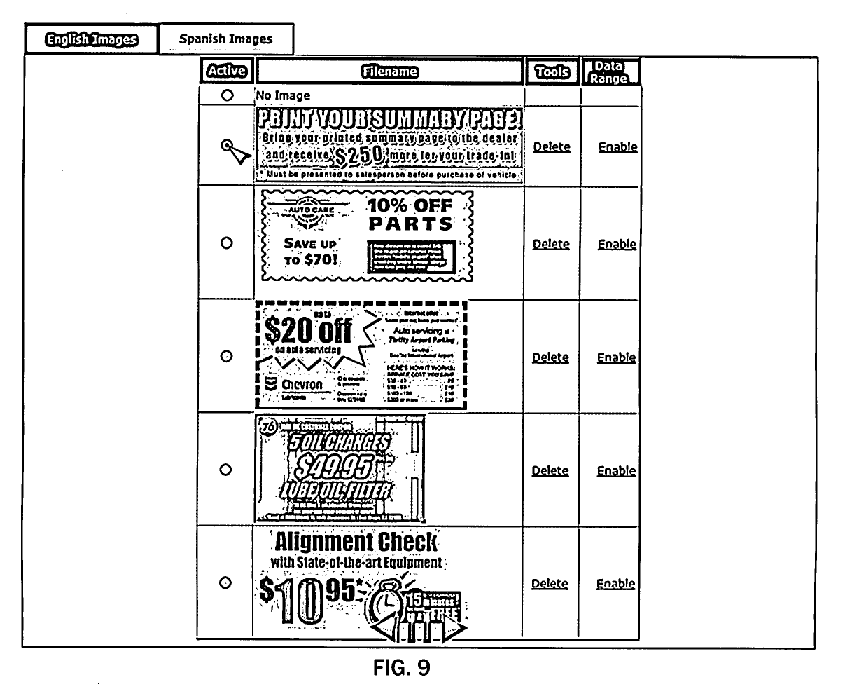

FIG. 9 shows a computer screenshot illustrating a portion of the configuration screen to allow a dealership to add multimedia aspects into the system's multimedia templates according to an embodiment of the present invention. The screenshot shows how a dealership can select one type of multimedia template that includes a special offer to encourage consumers to complete the contact information form.

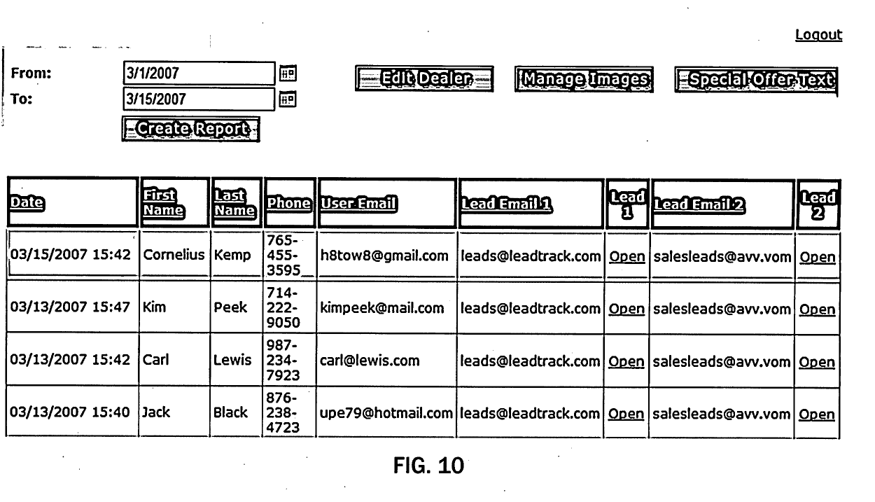

FIG. 10 shows a computer screenshot illustrating a portion of a lead report according to an embodiment of the present invention. The lead generation report is used by first filling out the from-date and to-date fields, either by typing, or using the calendar button immediately to the right of the fields. Next, the dealership would click the create report button. The lead-generation report would appear under the create report button. The lead generation report contains, on the front page, the date and time that the consumer completed the vehicle appraisal report, the first and last name of the consumer, the phone number, the e-mail address, the e-mail address that the lead report was sent to, and additional information regarding status. Other information collected in the contact information screen would be displayed here as well by clicking on any particular row and displaying a new web page. By clicking on one of these leads, the remainder of the information may be seen, such as, for example, the information related to the vehicle that was appraised, the value of the appraise vehicle, the new vehicle desired, preferences regarding the best time of contact, other comments, any date or time of the schedule appointment, and any other collected information.

The embodiments of this present invention shown in the drawings and depicted above are exemplary of numerous embodiments that may be made within the scope of the appended claims. It is contemplated that numerous other configurations of the software programs, program activities, database layouts, file formats, data schemas, computer languages, and computer hardware may be used. In short, it is the applicant's contention that the scope of the patent issuing herefrom will be limited only by the scope of the appended claims.

1. A system comprising the steps of:
storing electronically information regarding at least one used-vehicle, wherein such used-vehicle information includes at least one value related to such used-vehicle;
presenting, to a consumer over an network, a list of categories of such used-vehicle information within a structured document;
accepting inputting, from such consumer, a selection from such list;
modifying a portion of the structured document to include a sub list of categories of such used-vehicle information, wherein such sub-list derives from such selection;
repeating the step of accepting inputting and the step of modifying to determine such used-vehicle value, whereby such used-vehicle value relates to the selection of such consumer; and
presenting such used-vehicle value to such consumer.

2. The claim of claim 1 wherein:
such step of repeating occurs without re-presenting such structured document.

3. The claim of claim 1 wherein:
such step of accepting inputting further comprises the step of asynchronously receiving, via a httprequest, such selection; and
such step of modifying further comprises the step of asynchronously sending, via such httprequest, such sub list; and
such structured document comprises at least one selected from the group consisting of extensible markup language, hypertext markup language, really simple syndication and combinations thereof.

4. The claim of claim 1 wherein:
such step of asynchronously receiving further comprises the step of using javascript and extensible markup language.

5. The claim of claim 1 further comprising the steps of:
receiving the contact information of such consumer; and
allowing such contact information to be used by a vehicle dealership as a sales lead.

6. The claim of claim 1 further comprising the steps of:
receiving such used-car information from a data provider; and
representing to the consumer that such used-car value derive from such data provider.

7. The claim of claim 1 further comprising the steps of:
displaying to the consumer no more than three web pages.

8. The claim of claim 1 wherein:
such used-vehicle information comprises at least one selected from the group of make, model, year and combinations thereof.

9. The claim of claim 1 wherein:
such used-vehicle information comprises at least one selected from the group consisting of body style, engine, optional equipment, color, geographic location, and combinations thereof;
such step of modifying further comprises the step of displaying used-vehicle equipment value along with such sub list.

10. The claim of claim 1 wherein:
such used vehicle comprises a vehicle selected from the group consisting of a car, light-duty truck, sport-utility-vehicle, and combinations thereof.

11. The claim of claim 1 wherein:
such used vehicle comprises a vehicle selected from the group consisting of motorcycle, alternative-fuel vehicle, off-road vehicle, recreational vehicle or combinations thereof.

12. The claim of claim 1 further comprising the step of:
displaying the phone number of a vehicle dealership who conducts trade in such used-vehicle.

13. The claim of claim 1 wherein:
such step of repeating occurs without re-presenting such structured document;
displaying to the consumer no more than three web pages;
such step of accepting inputting further comprises the step of asynchronously receiving, via a httprequest, such selection;
such step of modifying further comprises the step of asynchronously sending, via such httprequest, such sub list;
such structured document comprises at least one selected from the group consisting of extensible markup language, hypertext markup language, really simple syndication and combinations thereof;
receiving the contact information of such consumer;
allowing such contact information to be used by a vehicle dealership as a sales lead;
receiving such used-car information from a data provider;
representing to the consumer that such used-car value derive from such data provider;
such used-vehicle information comprises at least one selected from the group of make, model, year and combinations thereof; and
such step of modifying further comprises the step of displaying used-vehicle equipment value along with such sub list.

14. A system comprising the steps of:
offering, over a globally connected computer network, to provide a used-vehicle appraisal to a consumer;
collecting, over such globally connected computer network, used-vehicle information to identify the used-vehicle of such consumer;
presenting, over a globally connected computer network, a used-vehicle appraisal of the used-vehicle of such consumer; and
setting an appointment for such consumer to visit a used-vehicle dealership.

15. The claim of claim 14 further comprising the step of:
allowing inputting, over a globally connected computer network, a calendar date and time for such appointment by such consumer.

16. The claim of claim 14 further comprising the step of:
automatically preventing selecting, over a globally connected computer network, a calendar date and time for such appointment whenever a dealership representative is not available.

17. The claim of claim 14 further comprising the step of:
automatically reminding such consumer of such appointment after setting such appointment and before such calendar date and time of such appointment.

18. The claim of claim 14 wherein:
such used-vehicle information comprises at least one selected from the group of make, model, year and combinations thereof.

19. The claim of claim 14 wherein:
such used vehicle comprises a vehicle selected from the group consisting of a car, light-duty truck, sport-utility-vehicle, and combinations thereof.

20. The claim of claim 14 wherein:
such used vehicle comprises a vehicle selected from the group consisting of motorcycle, alternative-fuel vehicle, off-road vehicle, recreational vehicle or combinations thereof.

21. The claim of claim 14 wherein:
displaying the phone number of a vehicle dealership who conducts trade in such used-vehicle.

22. The claim of claim 14 further comprising the steps of:
allowing inputting, over a globally connected computer network, a calendar date and time for such appointment by such consumer.
automatically preventing selecting, over a globally connected computer network, a calendar date and time for such appointment whenever a dealership representative is not available.
automatically reminding such consumer of such appointment after setting such appointment and before such calendar date and time of such appointment.
such used-vehicle information comprises at least one selected from the group of make, model, year and combinations thereof.
such used vehicle comprises a vehicle selected from the group consisting of a car, light-duty truck, sport-utility-vehicle, and combinations thereof.

23. A system comprising the steps of:
offering to provide a used-vehicle appraisal to a consumer;
prompting, using multimedia over a globally connected computer network, the consumer to input used-vehicle information;
prompting, using multimedia over a globally connected computer network, the consumer to input contact information; and
presenting, over a globally connected computer network, a used-vehicle appraisal to the consumer.

24. The claim of claim 23 wherein:
multimedia comprises video, audio or combinations thereof.

25. The claim of claim 23 wherein:
multimedia comprises an aspect provided by anyone other than the dealership; and
multimedia further comprises text overlaying such aspect, wherein such text is supplied by the vehicle dealership.

26. The claim of claim 25 wherein:
such aspect further comprises at least one offer selected from the group consisting of manufacturer's incentives, dealership incentives, lender's incentives, lease company incentives, and combinations thereof.

27. The claim of claim 23 wherein:
multimedia comprises audio.

28. The claim of claim 27 further comprising the steps of:
determining the network address of such consumer;
determining network-address information related to such network address; and
modify the multimedia using information related to such network address.

29. The claim of claim 28 wherein:
such network-address information comprises the type of entity to whom the network address is publicly registered.

30. The claim of claim 28 wherein:
such network-address information comprises the local time of day for the geography of the network address.

31. The claim of claim 23 wherein:
multimedia comprises video, audio or combinations thereof;
multimedia comprises an aspect provided by anyone other than the dealership;
multimedia further comprises text overlaying such aspect, wherein such text is supplied by the vehicle dealership;
determining the network address of such consumer;
determining information related to such network address; and
modify the multimedia using information related to such network address;
wherein such network-address information comprises the type of entity to whom the network address is publicly registered; and
wherein such network-address information comprises the local time of day for the geography of the network address.
